(19) United States
(12) Patent Application Publication
(10) Pub. No.: US 2026/0170737 A1
(43) Pub. Date: Jun. 18, 2026

(54) VIDEO GENERATION NEURAL NETWORKS WITH CAMERA AND SUBJECT MOTION INPUTS

(71) Applicant: GDM Holding LLC, Mountain View, CA (US)

(72) Inventors: Yu Qing Du, London (GB); Hyun Jik Kim, London (GB); Mohammad Babaeizadeh, San Jose, CA (US); Matthew David McGill, Milton Keynes (GB); Benjamin Michael Poole, San Francisco, CA (US); Aleksander Karim Holynski, Seattle, WA (US)

(21) Appl. No.: 19/421,916

(22) Filed: Dec. 16, 2025

Related U.S. Application Data
(60) Provisional application No. 63/734,713, filed on Dec. 16, 2024.
(60) Provisional application No. 63/809,236, filed on May 20, 2025.

(51) Int. Cl. G06T 13/00; G06T 7/246; G06T 11/00

(52) U.S. Cl. CPC G06T 13/00; G06T 7/246; G06T 11/00; G06T 2207/10016; G06T 2207/20081; G06T 2207/20084

(57) ABSTRACT

Methods, systems, and computer programs are described for generating camera motion descriptions and generating videos. A method includes obtaining a video comprising a sequence of video frames and generating camera track data specifying a position of the camera for at least a subset of the frames. For segments of the video, an input is generated from the camera track data and processed using a generative neural network to generate a text description of the camera motion during the segment. This description can be used to train a video generation neural network. The trained video generation neural network may then generate output videos in response to conditioning inputs that specify a target camera motion, a target subject motion, or both.

### CROSS-REFERENCE TO RELATED APPLICATIONS

This application claims the benefit of U.S. Provisional Application Nos. 63/734,713, filed on Dec. 16, 2024, and 63/809,236, filed on May 20, 2025. The disclosures of the prior applications are incorporated by reference in their entirety.

### BACKGROUND

This specification relates to generating videos using neural networks and to training neural networks to generate videos.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a system implemented as computer programs on one or more computers in one or more locations that uses a video generation neural network to generate videos in response to inputs that specify a target motion for the generated video. This specification also describes a training system that trains the video generation neural network to effectively generate videos in response to such inputs.

Particular embodiments of the subject matter described in this specification can be implemented so as to realize one or more of the following advantages.

Existing video generation neural networks can generate a wide variety of realistic, high-quality videos in response to a variety of conditioning inputs. However, these neural networks can struggle to generate videos that accurately capture various types of motion. As one example, these neural networks can struggle to generate videos that accurately depict camera motion. As another example, these neural networks can struggle to generate videos that accurately depict subject motion, i.e., accurately depict the motion of one or more subjects within the generated video.

This specification describes various techniques for addressing these issues and improving the ability of a video generation neural network to generate a video that accurately depicts camera motion, subject motion or both. In particular, by conditioning the video generation neural network on a conditioning input that includes a camera motion input, a subject motion input, or both, the described techniques cause the video generation neural network to generate a high-quality video that accurately represents the type (or types) of motion that are specified in the conditioning input.

This specification also describes a variety of techniques for improving the training of a video generation neural network to accurately condition on motion inputs. In particular, a challenge to training a video generation neural network in this manner is that large amounts of video data that is labeled with information identifying the types of motion that are present within the video are not available. This specification describes a variety of techniques for effectively generating this data. For example, by making use of a subject motion classifier, a camera motion classifier or both, as described in this specification, subject motion labels, camera motion labels, or both, can effectively be generated for previously unlabeled images. This allows the system to transform an initial training data set of videos into one that can effectively be used to train the video generation neural network to effectively incorporate motion conditioning. As another example, by making use of a generative neural network to map camera track data to camera motion labels, the system can (i) accurately generate improved training data for training such a classifier, (ii) directly use the labels generated by the generative neural network to improve the training data used to train the video generation neural network, or (iii) both.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example inference system and an example training system.

FIG. 2 is a flow diagram of an example process for generating an output video.

FIG. 3 is a flow diagram of an example process for training the video generation neural network.

FIG. 4 is a flow diagram of another example process for training the video generation neural network.

FIG. 5 is a flow diagram of an example process for generating a camera motion label using a generative neural network.

FIG. 6 is a diagram of an example user interface for a video editing suite that facilitates pre-visualization by decoupling camera and subject motion inputs.

FIG. 7 illustrates an example user interface for selecting specific camera motion types (e.g., orbits, dollies) to condition the video generation.

FIG. 8 is a block diagram illustrating a system for generating synthetic training data for autonomous systems by decoupling ego-motion from dynamic object motion.

Like reference numbers and designations in the various drawings indicate like elements.

### DETAILED DESCRIPTION

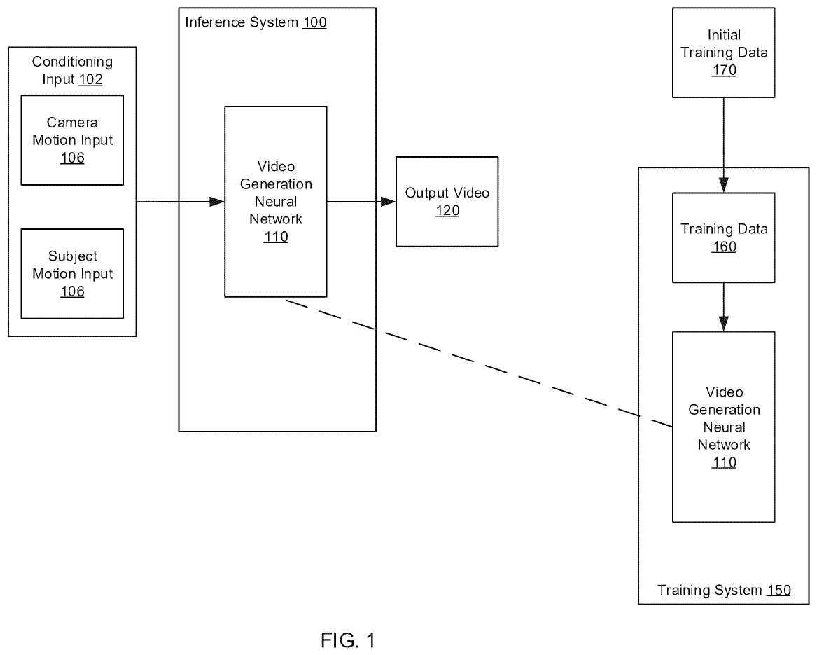

FIG. 1 shows an example inference system 100 and an example training system 150. The inference system 100 and training system 150 are examples of systems each implemented as computer programs on one or more computers in one or more locations, in which the systems, components, and techniques described below can be implemented.

The inference system 100 uses a video generation neural network 110 to generate videos 120.

Prior to the inference system 100 using the video generation neural network 110 to generate videos, the training system 150 trains the video generation neural network 110 on training data 160.

The video generation neural network 110 can be any appropriate neural network that maps a conditioning input 102 to a video 120 that includes multiple video frames and that spans a corresponding time window.

For example, the video generation neural network 110 can be a diffusion neural network. One example of such a neural network is described in Imagen Video: High Definition Video Generation with Diffusion Models, available at arXiv:2210.02303.

As a particular example of this, the video generation neural network 110 can be a latent diffusion neural network. One example of such a neural network is described in Photorealistic Video Generation with Diffusion Models, available at arXiv:2312.06662.

As another example, the video generation neural network 110 can be a rectified flow generative neural network. One example of such a neural network is described in Flow Straight and Fast: Learning to Generate and Transfer Data with Rectified Flow, available at arXiv:2209.03003.

As yet another example, the video generation neural network 110 can be a multistep consistency generative neural network. One example of such a neural network is described in Multistep Consistency Models, available at arXiv:2403.06807.

In particular, the system 100 obtains a conditioning input 102 characterizing an output video 120 and processes the conditioning input 102 using the video generation neural network 110 to generate an output video 120 that spans a particular time window.

In particular, the conditioning input 102 includes (i) a camera motion input 104 that specifies target motion of a camera that captures the output video during the particular time window, (ii) a subject motion input 106 that specifies a target motion of a subject depicted in the output video during the particular time window, or (iii) both. That is, the camera motion input 104 represents the desired motion of the camera capturing the video during the particular time window, even if the underlying scene depicted by the camera remains static. The subject motion input 106, on the other hand, represents the desired motion of a subject depicted in the video, even if the camera capturing the video remains static. The “subject” can be any appropriate object or collection of objects depicted in the video, e.g., a person, a vehicle, an animal, a ball or other inanimate object, and so on.

The camera motion input 104 can specify the target motion of the camera in any of a variety of ways.

For example, the camera motion input 104 can be a freeform natural language input that specifies the target motion of the camera. Examples of such freeform natural language inputs include “pan the camera left,” “tilt the camera down,” “zoom the camera out,” and so on.

As another example, the camera motion input 104 can be one of a set of camera motion labels that each represent a different camera motion. For example, the labels can be predetermined prior to the training of the video generation neural network 110.

The camera motion labels can represent any of a variety of different camera motions.

For example, the set of labels can include a respective label for each of one or more of the following: no motion (i.e., the camera remains static), pan left (i.e., the camera pans to the left), pan right (i.e., the camera pans to the right), tilt down (i.e., the camera tilts down), tilt up (i.e., the camera tilts up), zoom in (i.e., the camera zooms in), or zoom out (i.e., the camera zooms out). In addition or instead, the set of labels can include one or more labels that represent motion of a dolly or other apparatus on which the camera is mounted. e.g., moving the dolly left, right, forward, or back, and so on. Other types of camera motion labels are possible.

As another example, the camera motion input 104 can include a respective score for each of the set of camera motion labels, e.g., the set described above. The score for any given label represents a degree to which or, equivalently, the strength with which, the camera should perform the corresponding camera motion. When two or more labels have non-zero scores, the camera can perform each of the two or more camera motions during the particular time window. For example, when the labels tilt up and zoom in both have non-zero scores, the camera can both zoom in and tilt up during the particular time window.

The subject motion input 106 can specify the target motion of the subject in any of a variety of ways.

For example, the subject motion input 106 can be a freeform natural language input that specifies the target motion of the subject. Examples of such inputs include “keep the object still,” “move the person to the left,” “have the car drive off the screen.”

As another example, the subject motion input 106 can be one of a set of subject motion labels that each represent a different subject motion. For example, the labels can be predetermined prior to the training of the video generation neural network 110.

The subject motion labels can represent any of a variety of different subject motions. For example, the set of labels can include a respective label for each of one or more of the following: no motion (i.e., the subject remains static), moderate motion (i.e., the subject exhibits moderate motion during the time window), dynamic motion (i.e., the subject is a dynamic object that moves for at least a threshold portion of the time window), and so on.

As another example, the subject motion input 106 can include a respective score for each of the set of subject motion labels, e.g., the set described above. The score for any given label represents a degree to which or, equivalently, the strength with which, the subject should perform the corresponding subject motion. When two or more labels have non-zero scores, the subject can perform each of the two or more subject motions during the particular time window.

In cases where the conditioning input 102 includes both a camera motion input 104 and a subject motion input 106, i.e., the input 102 specifies target movement for both the camera and the subject depicted in the video, the subject motion input can specify the target motion of the subject relative to the target motion of the camera during the particular time window. This is as opposed to the absolute motion of the subject, measured independently of the motion of the camera.

In addition to the camera motion input 104, the subject motion input 106, or both, the conditioning input 102 can include any of a variety of additional inputs that describe other target properties of the output video 120.

For example, the conditioning input 102 can include a text prompt that describes the target content or style of the output video 120.

As another example, the conditioning input 102 can include a prompt image, e.g., that represents a target initial frame of the video or that provides visual context for the output video 120.

As yet another example, the conditioning input 102 can include an audio prompt, e.g., that serves as the soundtrack for the output video 120.

The inference system 100 then processes the conditioning input 102 using the video generation neural network 110 to generate the output video 120.

Once generated, the system 100 can use the video 120 for any of a variety of purposes.

For example, the system 100 can provide the video to a user device for presentation or playback to a user. For example, the system can have received the conditioning input 102 from the user device and can provide the video 120 in response to the conditioning input 102.

For example, the system 100 can provide the video 120 to an external system. For example, the system can have received the conditioning input 102 from the external system, e.g., through an application programming interface (API) or another interface, and can provide the video 120 in response to the conditioning input 102.

As another example, the system 100 can store the video 120 in a repository accessible to the system for later access.

In some implementations, the system can be integrated into a video editing suite to facilitate pre-visualization (‘pre-viz’) for film production. For example, a user (e.g., a director or cinematographer) can provide conditioning inputs that explicitly decouple camera maneuvers (e.g., a ‘dolly zoom’ or ‘truck left’) from the actions of actors or objects (e.g., ‘subject runs forward’). This allows the system to rapidly generate multiple iterations of a specific scene with varying camera angles while maintaining consistent subject behavior, or conversely, to test different actor blockings against a fixed camera trajectory. This capability enables the synthesis of high-fidelity video drafts.

In some implementations, the system generates synthetic training data for autonomous systems, such as self-driving vehicles or mobile robots. In this context, the ‘camera motion input’ can correspond to the ego-motion of the autonomous agent (e.g., a vehicle moving forward at a specific velocity or turning), while the ‘subject motion input’ corresponds to the behavior of dynamic obstacles in the environment (e.g., a pedestrian crossing the street or another vehicle changing lanes). By independently controlling these variables, the system can generate rare or dangerous ‘edge case’ scenarios—such as a vehicle swerving (high camera motion) to avoid a sudden obstacle (high subject motion)—that are difficult or unsafe to capture in the real world. This synthetic data can then be used to train or validate perception models for the autonomous systems. Once trained, the autonomous system (e.g., self-driving vehicle or robot) can be used in a real-world environment to perform a task, such as navigation to a particular destination, manipulation of objects located in the real-world environment, and so on.

In some implementations, the system is configured to generate dynamic background assets or textures for Virtual Reality (VR). The system can receive real-time or pre-recorded telemetry data from a user's head-mounted display (HMD) or controller, which serves as the ‘camera motion input’ (e.g., corresponding to the user's head pitch, yaw, and roll). Simultaneously, the system receives state logic defining the ‘subject motion input’ (e.g., the movement of background subjects). The video generation neural network then synthesizes video content that perspectively matches the user's physical movements while ensuring that the subjects within the virtual world behave according to the environment logic, providing a cohesive and immersive visual experience.

In some implementations, the system is used to generate synthetic training environments for physical robotic agents (Sim-to-Real transfer). Training robots in the real world is often unsafe or resource-intensive. The system generates video sequences representing a robot's visual input where the ‘camera motion input’ corresponds to the robot's own actuation commands (e.g., moving a robotic arm-mounted camera) and the ‘subject motion input’ simulates independent environmental dynamics (e.g., a moving conveyor belt or a falling object). This allows for the verification of robotic control algorithms against rare or hazardous motion combinations without risking physical damage to the hardware.

In some implementations, the system synthesizes video data for medical training or surgical planning, such as virtual endoscopy. The ‘camera motion input’ is derived from the tracked movement of a surgical instrument or probe, while the ‘subject motion input’ simulates the physiological movement of internal organs (e.g., peristalsis or heartbeats). This provides a technical tool for surgeons to navigate a virtual model of a patient's anatomy that reacts dynamically to instrument movement, improving the accuracy of surgical navigation systems prior to invasive procedures.

In some implementations, the system facilitates low-latency teleoperation of remote vehicles (e.g., drones or rovers) over high-latency connections. Instead of waiting for the video feed to return from the remote vehicle, the local control station uses the operator's control inputs (as the ‘camera motion input’) and a predictive model of the environment (the ‘subject motion’) to instantaneously synthesize a predicted video feed. This provides the operator with immediate visual feedback of their control actions, compensating for network round-trip time (RTT) and improving the precision of the man-machine interface.

Prior to the inference system 100 using the video generation neural network 110 to generate videos 120 from conditioning inputs 102 that include camera motion inputs 104, subject motion inputs 106, or both, the training system 150 trains the video generation neural network 110 to effectively generate outputs that reflect the target motion specified by the camera motion inputs, the subject motion inputs, or both.

In some cases, the system 150 performs this training starting from an already-trained version of the video generation neural network 110, e.g., one that has been trained to generate videos from conditioning inputs that do not include camera motion inputs or subject motion inputs. For example, the system 150 or another training system can have trained the video generation neural network 110 on training data that includes videos and corresponding conditioning inputs that each include a text description of the corresponding video.

To train the video generation neural network, the system 150 can obtain initial training data 170 that includes a plurality of initial training examples. Each initial training example includes (i) an initial conditioning input and (ii) a target video that spans a corresponding time window and is characterized by the initial conditioning input. For example, these can be the same training examples that have been used to “pre-train” the video generation neural network 110 or can be a different set of training examples.

The system then generates the training data 160 that will be used to train the video generation neural network 110 by generating a respective camera motion input, a respective subject motion input, or both, for each initial training example.

For example, when training the neural network 110 to process conditioning inputs that include camera motion, for any given initial training example, the system 150 can process a first input that includes (i) the target video in the initial training example or (ii) features of the target video in the initial training example using a camera motion classifier neural network to generate a camera motion output that characterizes a motion of a camera that captured the target video during the corresponding time window.

As another example, when training the neural network 110 to process conditioning inputs that include subject motion, the system 150 can process a second input that includes (i) the target video in the initial training example or (ii) features of the target video in the initial training example using a subject motion classifier neural network to generate a subject motion output that characterizes a motion of a subject depicted in the target video during the corresponding time window.

In either example, when features of the target video are used, the features of the target video can be features of an optical flow prediction generated from the target video by processing the target video using an optical flow prediction neural network. For example, this neural network can have been trained on a large data set of training videos through unsupervised learning. One example of such a neural network is described in RAFT: Recurrent All-Pairs Field Transforms for Optical Flow, available at arXiv:2003.12039. Providing the optical flow predictions instead of or in addition to the target video can provide the corresponding motion classifier with additional information regarding motion within the target video for use in accurately classifying the corresponding type of motion occurring within the target video.

Generally, the output of the optical flow prediction neural network for any given frame is a respective optical flow vector for each pixel of the video frame that represents predicted motion of the pixel between the frame and an adjacent video frame.

The system 150 can generate any of a variety of features from these optical flow predictions.

For example, the features can include the optical flow vectors for the video frames.

As another example, the features can be based on, for each of one or more video frames, respective magnitudes of the optical flow vectors for pixels of the video frame. For example, the features can include the respective magnitudes or can include normalized vectors generated by normalizing the optical flow vectors using the magnitudes.

As another example, the features of the optical flow prediction can be based on, for each of one or more video frames, respective centered magnitudes of optical flow vectors for pixels of the video frame. These features can be computed by subtracting, from each optical flow vector, a per-frame median displacement from the optical flow vector or from the magnitude of the optical flow vector.

As another example, the features of the optical flow prediction can be based on, for each of one or more video frames, respective optical flow angles for pixels of the video frame. For example, these can be the sine, cosine, or both, of the optical flow angles defined by the optical flow vectors for the pixels of the video frame.

In some implementations, when both camera and subject motion are used, the subject motion classifier neural network and the camera motion classifier neural network are different neural networks, i.e., different neural networks trained to perform the corresponding prediction task on respective sets of training data.

For example, the subject motion classifier neural network and the camera motion classifier neural network can be respective convolutional neural networks or vision Transformer neural networks that are each trained to generate a corresponding motion output.

For example, the output of the camera motion classifier can include a respective score for each of the camera motion labels described above. The system can then select, for inclusion in the final training example, the highest scoring camera motion label, or the system can sample a camera motion label in accordance with the scores, or the system can include, as the camera motion label, the respective scores in the camera motion output.

Similarly, the output of the subject motion classifier can include a respective score for each of the subject motion labels described above. The system can then select, for inclusion in the final training example, the highest scoring subject motion label, or the system can sample a subject motion label in accordance with the scores, or the system can include, as the subject motion label, the respective scores in the subject motion output.

In some other implementations, the subject motion classifier neural network and the camera motion classifier neural network are the same neural network and the first input is the same as the second input. That is, in these implementations, the system 150 processes a single input to generate both the camera and subject motion outputs.

For example, the subject motion classifier neural network and the camera motion classifier neural network can be a single convolutional neural network or vision Transformer neural network that has been trained to generate both a subject and a camera motion output.

The system 150 can then generate a final training example for inclusion in the training data 160 that includes (i) a conditioning input that includes the initial conditioning input in the initial training example and the camera motion output, the subject motion output, or both and (ii) the target video in the initial training example.

The system 150 can then train the video generation neural network 110 on the final training examples, e.g., to optimize an objective that is appropriate for the type of video generation neural network being trained.

In some cases, instead of or in addition to using the camera motion classifier or the subject motion classifier, the system can make use of a generative neural network, e.g., a language model neural network, e.g., a multi-modal language model neural network. Examples of such neural networks include large language models (LLMs), which can be either a text-only language model or a multi-modal language model neural network. Examples of large language models include PaLM, PaLM 2, Gemini, and Gemma.

For example, the system 150 can use an already-trained generative neural network and can cause the generative neural network to generate camera motion labels or subject motion labels through natural language instructions, few-shot prompting, or both.

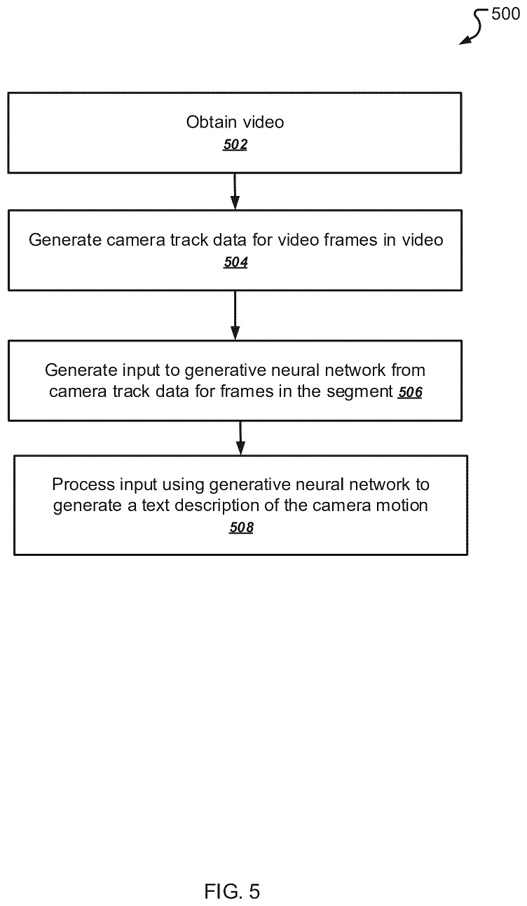

Using the generative neural network to generate motion labels will be described in more detail below with reference to FIG. 5.

The system 150 can use the labels generated by the generative neural network directly to train the video generation neural network 110 as described above, to train the camera motion classifier, or both.

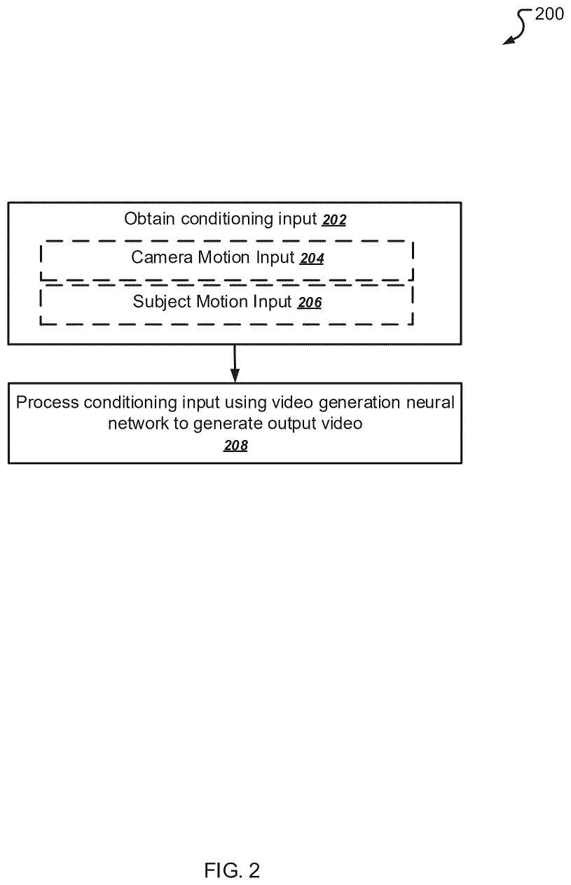

FIG. 2 is a flow diagram of an example process 200 for generating an output video. For convenience, the process 200 will be described as being performed by a system of one or more computers located in one or more locations. For example, an inference system, e.g., the inference system 100 depicted in FIG. 1, appropriately programmed in accordance with this specification, can perform the process 200.

The system obtains a conditioning input for generating an output video that spans a particular time window (step 202).

As described above, the conditioning input includes a camera motion input (204), a subject motion input (206), or both.

That is, as one example, the conditioning input can include a camera motion input that specifies a target motion of a camera that captures the output video during the particular time window.

As another example, the output video can depict a subject, and the conditioning input can include a subject motion input that specifies a target motion of the subject during the particular time window.

Example types of camera motion and subject motion inputs are described above with reference to FIG. 1.

The system processes the conditioning input using a video generation neural network to generate the output video (step 208). The output video depicts the camera motion, the subject motion, or both specified by the conditioning input.

As one example, to process the conditioning input using the video generation neural network, the system can tokenize the camera motion input, the subject motion input, or both, into a respective set of tokens. For example, the system can represent each input as a respective sequence of text and can apply a text tokenizer to the sequence of text to generate the respective set of tokens representing the input. Alternatively, the system can use a learned tokenizer that maps each type of conditioning input into a respective set of tokens. This tokenizer can have been learned jointly during the training of the video generation neural network.

The system can then condition the video generation neural network on the respective set(s) of one or more tokens.

As one example, when the subject motion input is a subject motion label, the system can tokenize the subject motion label into a set of one or more tokens and condition the video generation neural network on the set of one or more tokens.

As another example, when the subject motion input includes a respective score for each of a set of a plurality of subject motion labels, the system can tokenize the respective scores for the subject motion labels into a set of one or more tokens and condition the video generation neural network on the set of one or more tokens.

As another example, when the camera motion is a camera motion label, the system can tokenize the camera motion label into a set of one or more tokens and condition the video generation neural network on the set of one or more tokens.

As another example, when the camera motion input includes a respective score for each of a set of a plurality of camera motion labels, the system can tokenize the respective scores for the camera motion labels into a set of one or more tokens and condition the video generation neural network on the set of one or more tokens.

Optionally, prior to conditioning the neural network on the tokens, the system can encode each token in the respective set(s) of one or more tokens with a respective temporal positional encoding, e.g., by adding the respective temporal positional encoding with the token or by concatenating the temporal positional encoding and the token. For example, the positional encodings can be learned encodings or can be static encoding, e.g., integer-based encoding or sinusoidal encoding, that represent a respective temporal position within the output video.

The video generation neural network can be conditioned on the tokens in any of a variety of ways, depending on the architecture of the video generation neural network. As one example, the video generation neural network can include one or more cross-attention layers that cross-attend into the respective set(s) of one or more tokens. As another example, the video generation neural network can include one or more Feature-wise Linear Modulation (FiLM) layers that condition on the respective set(s) of one or more tokens. As yet another example, the respective set(s) of one or more tokens can be concatenated with a set of tokens representing the output video at the input layer or an intermediate layer of the video generation neural network.

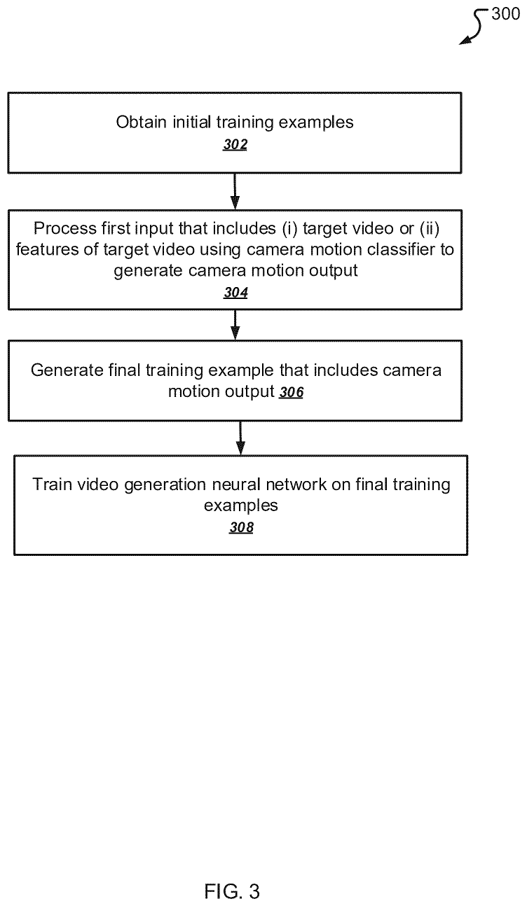

FIG. 3 is a flow diagram of an example process 300 for training the video generation neural network. For convenience, the process 300 will be described as being performed by a system of one or more computers located in one or more locations. For example, a training system, e.g., the training system 150 depicted in FIG. 1, appropriately programmed in accordance with this specification, can perform the process 300.

The system obtains a plurality of initial training examples (step 302). Each training example includes (i) an initial conditioning input and (ii) a target video that spans a corresponding time window and is characterized by the initial conditioning input.

The system performs steps 304 and 306 for each initial training example.

The system processes a first input that includes (i) the target video in the initial training example or (ii) features of the target video in the initial training example using a camera motion classifier neural network to generate a camera motion output that characterizes a motion of a camera that captured the target video during the corresponding time window (step 304).

When features of the target video are used, the features of the target video can be features of an optical flow prediction generated from the target video by processing the target video using an optical flow prediction neural network. For example, this neural network can have been trained on a large data set of training videos through unsupervised learning. One example of such a neural network is described in RAFT: Recurrent All-Pairs Field Transforms for Optical Flow, available at arXiv:2003.12039. Providing the optical flow predictions instead of or in addition to the target video can provide the corresponding motion classifier with additional information regarding motion within the target video for use in accurately classifying the corresponding type of motion occurring within the target video.

The system then generates a final training example that includes (i) a conditioning input that includes the initial conditioning input in the initial training example and the camera motion output and (ii) the target video in the initial training example (step 306).

Optionally, the final training examples can include both a camera motion output and a subject motion output, e.g., generated as described above with reference to FIG. 1.

The system trains the video generation neural network on the final training examples (step 308).

In some cases, the system pre-processes each training example in the set of training data used for the training of the video generation neural network to generate the camera motion outputs. In some other cases, the system generates the camera motion outputs each time a new batch of training examples is sampled for use in training the video generation neural network.

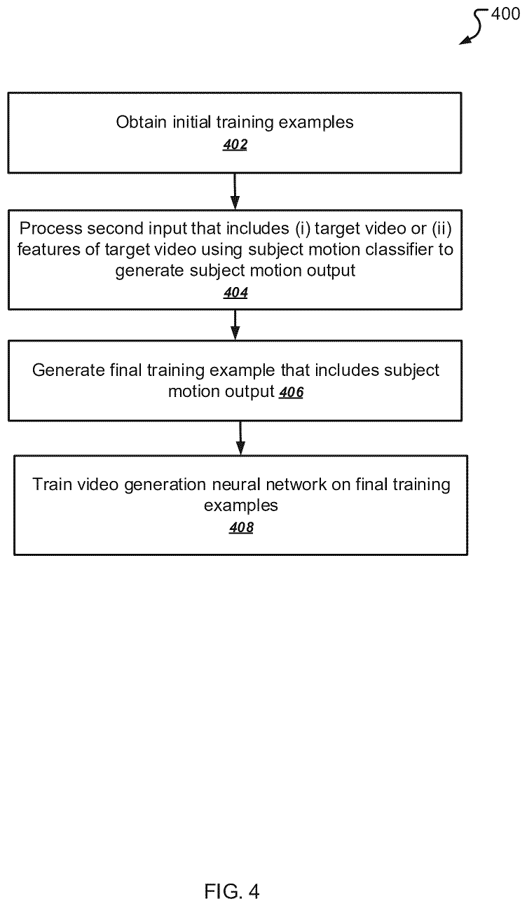

FIG. 4 is a flow diagram of another example process 400 for training the video generation neural network. For convenience, the process 400 will be described as being performed by a system of one or more computers located in one or more locations. For example, a training system, e.g., the training system 150 depicted in FIG. 1, appropriately programmed in accordance with this specification, can perform the process 400.

The system obtains a plurality of initial training examples (step 402). Each training example includes (i) an initial conditioning input and (ii) a target video that spans a corresponding time window and is characterized by the initial conditioning input.

The system performs steps 404 and 406 for each initial training example.

The system processes a second input that includes (i) the target video in the initial training example or (ii) features of the target video in the initial training example using a subject motion classifier neural network to generate a subject motion output that characterizes a motion of a subject depicted in the target video during the corresponding time window (step 404).

When features of the target video are used, the features of the target video can be features of an optical flow prediction generated from the target video by processing the target video using an optical flow prediction neural network. For example, this neural network can have been trained on a large data set of training videos through unsupervised learning. One example of such a neural network is described in RAFT: Recurrent All-Pairs Field Transforms for Optical Flow, available at arXiv:2003.12039. Providing the optical flow predictions instead of or in addition to the target video can provide the corresponding motion classifier with additional information regarding motion within the target video for use in accurately classifying the corresponding type of motion occurring within the target video.

The system then generates a final training example that includes (i) a conditioning input that includes the initial conditioning input in the initial training example and the subject motion output and (ii) the target video in the initial training example (step 406).

Optionally, the final training examples can include both a subject motion output and a camera motion output, e.g., generated as described above with reference to FIG. 1.

The system trains the video generation neural network on the final training examples (step 408).

In some cases, the system pre-processes each training example in the set of training data used for the training of the video generation neural network to generate the subject motion outputs. In some other cases, the system generates the subject motion outputs each time a new batch of training examples is sampled for use in training the video generation neural network.

FIG. 5 is a flow diagram of an example process 500 for generating camera motion labels using a generative neural network. For convenience, the process 500 will be described as being performed by a system of one or more computers located in one or more locations. For example, a training system, e.g., the training system 150 depicted in FIG. 1, appropriately programmed in accordance with this specification, can perform the process 500.

The system obtains a video captured by a camera (step 502). The video includes a sequence of a plurality of video frames.

The system generates, for each of at least a subset of the plurality of video frames, respective camera track data specifying a position of the camera when the video frame was captured (step 504). Generally, the respective camera track data includes a three-dimensional camera position and orientation of the camera when the video frame was captured. For example, the camera track data for a given video frame can include a three-dimensional position of the camera in a three-dimensional coordinate system as of the given video frame and the pitch, roll, and yaw of the camera as of the video frame.

In some cases, the system can apply a camera posing algorithm to the video to generate the camera track data. For example, the camera posing algorithm can be a Simultaneous Localization and Mapping (SLAM)-based algorithm, e.g., the ORB-SLAM, ORB-SLAM2, or ORB-SLAM3 algorithms. More generally, however, any appropriate video camera pose estimation algorithm can be used. When applying the camera posing algorithm, the algorithm may fail to track the camera pose for certain frames in the video, e.g., due to occlusions, drastic scene changes or other reasons.

The system then performs steps 506 and 508 for each of a set of one or more segments of the video.

For example, the set of segments can include only a single segment which includes all of the frames in the video.

As another example, the set of segments can include multiple segments, each of which is a disjoint subset of the frames in the video.

As a particular example of this, the system can divide the video into a plurality of segments, e.g., of equal length or using another appropriate technique for segmenting videos. For each of the segments of the video, the system can determine whether at least a threshold proportion of the video frames in the segment have respective camera track data. That is, as described above, camera track data may only be available for some (but not all) of the video frames in the video. The system can then only include the segment in the set of one or more segments when at least a threshold proportion of the video frames in the segment have respective camera track data.

The system generates, from the respective camera track data for the video frames in the segment, an input to a generative neural network (step 506).

For example, as described above, the generative neural network can be a language model neural network, e.g., a text-only language model neural network or a multi-modal language model neural network.

To generate the input, the system can generate, from the respective camera track data for the video frames in the segment, a sequence of camera positions and rotation velocities of the camera. That is, the sequence includes, for some or all of the video frames in the segment, a camera position and rotation velocity of the camera that captured video as of the video frame in the segment. As a particular example, the sequence of camera positions and rotation velocities can include, for each of one or more video frames in the segment: a respective horizontal velocity of the camera as of the video frame; a respective vertical velocity of the camera as of the video frame; and a respective forward/backward velocity of the camera as of the video frame. Instead or in addition, the sequence of camera positions and rotation velocities can include, for each of one or more video frames in the segment, a respective pitch of the camera as of the video frame; a respective yaw of the camera as of the video frame; and a respective roll of the camera as of the video frame.

The input can also include additional information to assist the generative neural network in generating accurate outputs. For example, the input can also include one or more few-shot examples. Each few-shot example includes (i) an example input generated from example camera motion data for an example video segment, e.g., an example sequence of camera positions and rotation velocities, and (ii) an example text description describing motion of a camera during the example video segment. As another example, the input can, instead of or in addition to the few-shot example(s), include a natural language instruction that instructs the generative neural network to generate a description of the motion that is represented by the sequence of camera positions and rotation velocities.

The system processes the input using the generative neural network to generate a text description of motion of the camera during the video, i.e., during the segment of the video (step 508).

As a particular example, the generative neural network can map an input that includes the following sequence of camera positions and rotation velocities:
Right/Left Velocity (X): [0.0], [0.0], [0.0], [0.0], [0.0], [0.0], [−0.0], [−0.0], [0.0], [0.0], [0.0], [0.0], [0.0], [0.0], [0.0], [0.0], [0.0], [0.0], [0.0], [0.0], [0.0], [0.4], [0.5], [0.6], [0.6], [0.7], [0.8], [0.8], [0.9], [0.9], [0.9]
Up/Down Velocity (Y): [0.0], [0.0], [0.0], [0.0], [−0.0], [−0.0], [−0.0], [−0.0], [−0.0], [−0.0], [−0.0], [−0.0], [−0.0], [−0.0], [0.0], [0.0], [0.0], [0.0], [0.0], [0.0], [0.0], [0.0], [−0.0], [−0.0], [−0.0], [−0.0], [−0.0], [−0.0], [−0.0], [−0.0], [−0.0]
Forward/Backward Velocity (Z): [0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0], [−0.0]
Pitch (A): [0], [0], [0], [0], [0], [0], [0], [0], [0], [0], [0], [0], [0], [0], [0], [1], [1], [1], [1], [1], [1], [1], [1], [1], [1], [0], [0], [0], [0], [0], [0]
Yaw (B): [0], [0], [0], [0], [0], [0], [0], [0], [0], [0], [0], [0], [0], [0], [0], [0], [0], [0], [0], [0], [0], [0], [0], [0], [1], [1], [1], [1], [1], [1], [1]
Roll (C): [0], [−1], [0], [0], [0], [0], [0], [0], [−1], [−1], [−1], [−1], [−1], [−1], [−1], [0], [−1], [−1], [−1], [−1], [−1], [−1], [−1], [−1], [−1], [−1], [0], [0], [0], [0], [0]

Into the following label:
Move the camera to the right while looking slightly upward and turning slightly to the right.

Once generated, the system can use the text description as a label for the training of the camera motion classifier described above or can directly include the text description as the camera motion input in a training example corresponding to the segment for the training of the video generation neural network.

For example, when directly using the text description to train the video generation neural network, the system can generate a training example that includes (i) a training conditioning input that comprises the text description of the one or more segments of the video and (ii) a target output that comprises the one or more segments of the video; and train the video generation neural network on training data that includes the training example.

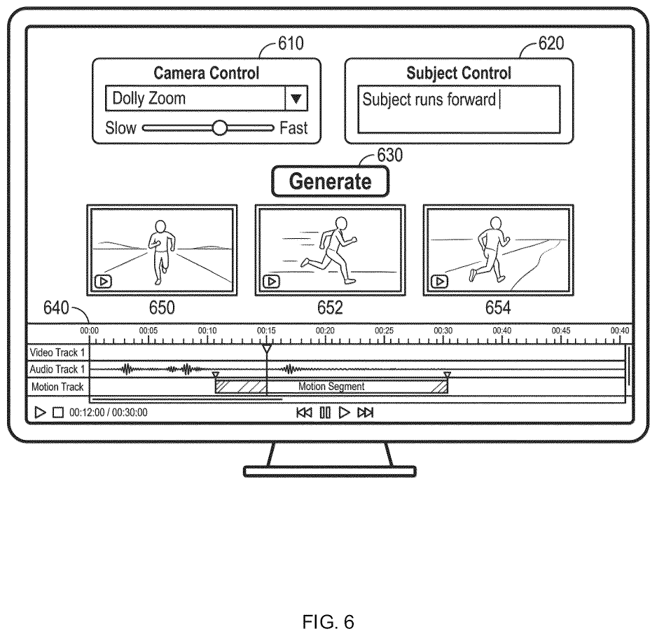

FIG. 6 illustrates an example user interface 600 for a video editing system that utilizes the video generation neural network 110 described above. The user interface 600 enables a user 602 to generate video content by explicitly decoupling camera maneuvers from subject actions.

The user interface 600 includes a camera motion control panel 610 and a subject motion control panel 620. The camera motion control panel 610 allows the user to specify the camera motion input 104. As shown in the example of FIG. 6, the user has selected a specific camera maneuver, “Dolly Zoom,” via a dropdown menu or text prompt 612. The panel may also include parameter adjustments 614, such as sliders for velocity, focal length, or shake intensity.

Distinct from the camera controls, the subject motion control panel 620 allows the user to specify the subject motion input 106. In this example, the user has input a command “Subject runs forward” into a subject prompt field 622. The system maintains these two inputs as disentangled control vectors.

Upon actuating a generation element 630 (e.g., a “Render” or “Generate” button), the system processes these independent inputs using the video generation neural network 110. The user interface 600 may further include a timeline interface 640 that visually represents the duration of the output video, allowing the user to synchronize the camera motion input 104 with specific frames or timecodes. Finally, the system displays the synthesized high-fidelity video draft 650.

In some implementations, this system is integrated into a video editing suite to facilitate pre-visualization (‘pre-viz’) for film production. By explicitly decoupling camera maneuvers (e.g., the ‘Dolly Zoom’ or ‘Truck Left’ selected in panel 610) from the actions of actors or objects (e.g., the ‘Subject runs forward’ in panel 620), the system allows the user to rapidly generate multiple iterations of a specific scene. For instance, the user can lock the subject motion settings in panel 620 and iterate only through different camera angles in panel 610 (e.g., generating a second version 652 with a ‘Static Camera’ and a third version 654 with a ‘Pan Right’). Conversely, the user can test different actor blockings against a fixed camera trajectory. This capability enables the synthesis of high-fidelity video drafts without requiring physical sets or actors, significantly reducing production time and costs.

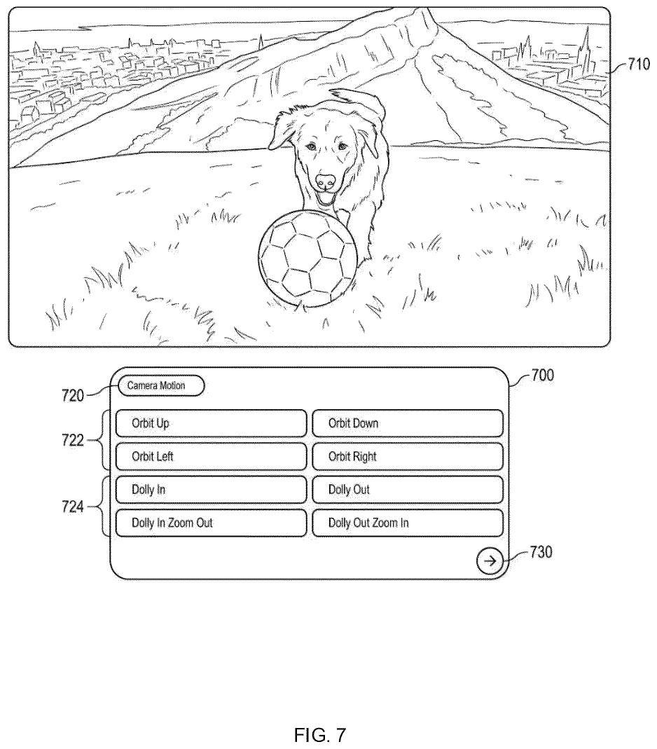

FIG. 7 shows an example user interface 700 for specifying camera motion inputs. The interface displays a video preview area 710 showing the current state of the generated video (e.g., a subject, such as a dog, in an environment). Below the preview, the interface includes a camera motion control panel 720.

In this implementation, the camera motion input 104 is presented as a set of discrete, selectable camera motion labels 722. These labels correspond to specific cinematic maneuvers, including “Orbit” motions (e.g., Orbit Up, Orbit Down, Orbit Left, Orbit Right) which rotate the camera around the subject.

Additionally, the interface may offer complex compound motion labels 724, such as “Dolly In Zoom Out”. By selecting one of these elements, the user generates a conditioning token corresponding to that specific camera trajectory. A navigation or generation element 730 allows the user to confirm the selection and proceed with the generation or refinement of the video clip.

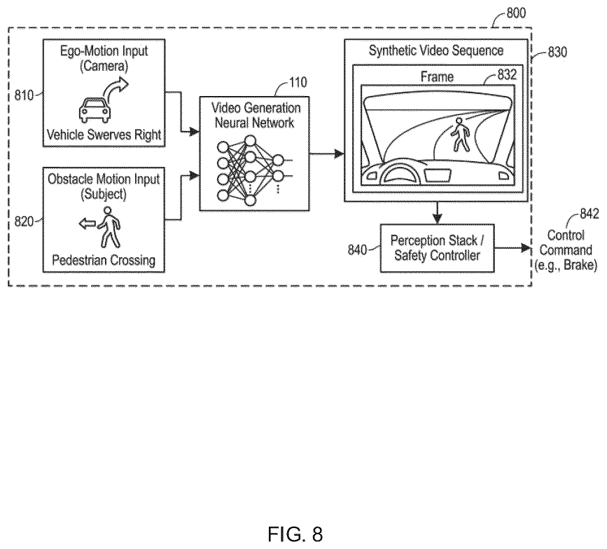

FIG. 8 illustrates a system implementation 800 configured for verifying or training an autonomous system, such as a self-driving vehicle or mobile robot. In this context, the conditioning inputs are structured to simulate specific “edge case” scenarios.

The system receives an ego-motion input 810 (functioning as the camera motion input), which defines the movement of the autonomous agent itself (e.g., “Vehicle swerves right” or a specific velocity vector). Simultaneously, the system receives an obstacle motion input 820 (functioning as the subject motion input), which defines the behavior of external dynamic agents (e.g., “Pedestrian runs left” or “Deer enters roadway”).

The video generation neural network 110 processes these inputs to synthesize a synthetic video sequence 830. As shown in the generated frame 832, the video depicts the scene from the perspective of the agent's sensors, accurately rendering the visual consequences of both the agent's swerve and the pedestrian's movement. This synthetic video 830 is then provided to a perception stack 840 (e.g., a collision avoidance module) of the autonomous system to validate its control response 842 (e.g., “Brake” or “Emergency Stop”). This allows for the technical validation of safety systems against dangerous scenarios without physical risk.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, a database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Innovative aspects of the present disclosure are also set out in the following numbered clauses.

Clause 1. A method performed by one or more computers, the method comprising:
obtaining a conditioning input for generating an output video that spans a particular time window, wherein the conditioning input comprises a camera motion input that specifies a target motion of a camera that captures the output video during the particular time window; and
processing the conditioning input using a video generation neural network to generate the output video.

Clause 2. The method of clause 1, wherein the output video depicts a subject, and wherein the conditioning input comprises a subject motion input that specifies a target motion of the subject during the particular time window.

Clause 3. The method of clause 2, wherein the subject motion input specifies the target motion of the subject relative to the target motion of the camera during the particular time window.

Clause 4. A method performed by one or more computers, the method comprising:
obtaining a conditioning input for generating an output video that depicts a subject and that spans a particular time window, wherein the conditioning input comprises a subject motion input that specifies a target motion of the subject during the particular time window; and
processing the conditioning input using a video generation neural network to generate the output video.

Clause 5. The method of clause 4, wherein the conditioning input comprises a camera motion input that specifies a target motion of a camera that captures the output video during the particular time window.

Clause 6. The method of clause 5, wherein the subject motion input specifies the target motion of the subject relative to the target motion of the camera during the particular time window.

Clause 7. The method of any preceding clause, wherein the subject motion input is one of a set of subject motion labels that each represent a different subject motion.

Clause 8. The method of clause 7, wherein processing the conditioning input using a video generation neural network to generate the output video comprises tokenizing the subject motion label into a set of one or more tokens and conditioning the video generation neural network on the set of one or more tokens.

Clause 9. The method of any preceding clause, wherein the camera motion input is one of a set of camera motion labels that each represent a different camera motion.

Clause 10. The method of clause 9, wherein processing the conditioning input using a video generation neural network to generate the output video comprises tokenizing the camera motion label into a set of one or more tokens and conditioning the video generation neural network on the set of one or more tokens.

Clause 11. The method of any one of clauses 1-6, wherein the subject motion input comprises a respective score for each of a set of a plurality of subject motion labels that each represent a different subject motion.

Clause 12. The method of clause 11, wherein processing the conditioning input using a video generation neural network to generate the output video comprises tokenizing the respective scores for the subject motion labels into a set of one or more tokens and conditioning the video generation neural network on the set of one or more tokens.

Clause 13. The method of any one of clauses 1-6, 11, or 12, wherein the camera motion input comprises a respective score for each of a set of a plurality of camera motion labels that each represent a different camera motion.

Clause 14. The method of clause 13, wherein processing the conditioning input using a video generation neural network to generate the output video comprises tokenizing the respective scores for the camera motion labels into a set of one or more tokens and conditioning the video generation neural network on the set of one or more tokens.

Clause 15. The method of any one of clauses 7-14, wherein each token in the set of one or more tokens is encoded with a respective temporal positional encoding.

Clause 16. The method of any preceding clause, wherein the video generation neural network is a video diffusion neural network.

Clause 17. The method of any preceding clause, wherein the video generation neural network is a video latent diffusion neural network.

Clause 18. The method of any preceding clause, wherein the conditioning input further comprises text or audio characterizing one or more properties of the output video.

Clause 19. The method of any preceding clause, wherein the conditioning input further comprises one or more context images for the output video.

Clause 20. A method performed by one or more computers and for training a video generation neural network that generates output videos conditioning on respective conditioning inputs, the method comprising:
obtaining a plurality of initial training examples, each training example comprising (i) an initial conditioning input and (ii) a target video that spans a corresponding time window and is characterized by the initial conditioning input;
for each initial training example:
   processing a first input comprising (i) the target video in the initial training example or (ii) features of the target video in the initial training example using a camera motion classifier neural network to generate a camera motion output that characterizes a motion of a camera that captured the target video during the corresponding time window; and
   generating a final training example that comprises (i) a conditioning input that comprises the initial conditioning input in the initial training example and the camera motion output and (ii) the target video in the initial training example; and
training the video generation neural network on the final training examples.

Clause 21. The method of clause 20, wherein, prior to training the video generation neural network on the final training examples, the video generation neural network has been trained on a set of training examples that do not include camera motion outputs.

Clause 22. The method of clause 20 or 21, wherein:
each target video depicts a respective subject,
the method further comprises, for each initial training example:
   processing a second input comprising (i) the target video in the initial training example or (ii) the features of the target video in the initial training example using a subject motion classifier neural network to generate a subject motion output that characterizes a motion of the respective subject depicted in the target video during the corresponding time window;
wherein the conditioning input in the final training example for the initial training example further comprises the subject motion output.

Clause 23. A method performed by one or more computers and for training a video generation neural network that generates output videos conditioning on respective conditioning inputs, the method comprising:
obtaining a plurality of initial training examples, each training example comprising (i) an initial conditioning input and (ii) a target video that spans a corresponding time window and is characterized by the initial conditioning input, wherein each target video depicts a respective subject;
for each initial training example:
   processing a second input comprising (i) the target video in the initial training example or (ii) the features of the target video in the initial training example using a subject motion classifier neural network to generate a subject motion output that characterizes a motion of the respective subject depicted in the target video during the corresponding time window; and
   generating a final training example that comprises (i) a conditioning input that comprises the initial conditioning input in the initial training example and the subject motion output and (ii) the target video in the initial training example; and
training the video generation neural network on the final training examples.

Clause 24. The method of clause 23, wherein the method further comprises, for each initial training example:
processing a first input comprising (i) the target video in the initial training example or (ii) features of the target video in the initial training example using a camera motion classifier neural network to generate a camera motion output that characterizes a motion of a camera that captured the target video during the corresponding time window;
wherein the conditioning input in the final training example for the initial training example further comprises the camera motion output.

Clause 25. The method of clause 22 or of clause 24, wherein the subject motion classifier neural network and the camera motion classifier neural network are different neural networks.

Clause 26. The method of clause 22 or clause 24, wherein the subject motion classifier neural network and the camera motion classifier neural network are the same neural network and the first input is the same as the second input.

Clause 27. The method of any one of clauses 22 or 24-26, when dependent on clause 21, wherein the training examples do not include subject motion outputs.

Clause 28. The method of any one of clauses 22-27, wherein the subject motion output specifies one of a set of subject motion labels that each represent a different subject motion.

Clause 29. The method of any one of clauses 22-27, wherein the subject motion output comprises a respective score for each of a set of subject motion labels that each represent a different subject motion.

Clause 30. The method of any one of clauses 22-29, wherein the subject motion output characterizes the motion of the respective subject depicted in the target video during the corresponding time window relative to the corresponding camera for the target video.

Clause 31. The method of any one of clauses 20-30, when dependent on clause 20 or clause 24 wherein the camera motion output specifies one of a set of camera motion labels that each represent a different camera motion.

Clause 32. The method of any one of clauses 20-30, when dependent on clause 20 or clause 24 wherein the camera motion output comprises a respective score for each of a set of camera motion labels that each represent a different camera motion.

Clause 33. The method of any one of clauses 20-32, when dependent on clause 20 or clause 24 wherein the first input comprises the features.

Clause 34. The method of any one of clauses 22-33, when dependent on clause 22 or clause 23 wherein the second input comprises the features.

Clause 35. The method of clause 33 or clause 34, wherein the features comprise features of an optical flow prediction for the video frames in the target video.

Clause 36. The method of clause 35, further comprising:
generating the features of the optical flow prediction for the video frames in the target video by processing the target video using an optical flow prediction neural network.

Clause 37. The method of clause 35 or clause 36, wherein the features of the optical flow prediction are based on, for each of one or more video frames, respective magnitudes of optical flow vectors for pixels of the video frame.

Clause 38. The method of clause 35, clause 36, or clause 37, wherein the features of the optical flow prediction are based on, for each of one or more video frames, respective centered magnitudes of optical flow vectors for pixels of the video frame that are computed by subtracting a per-frame median displacement from a magnitude of the optical flow vector.

Clause 39. The method of any one of clauses 35-38, wherein the features of the optical flow prediction are based on, for each of one or more video frames, respective optical flow angles for pixels of the video frame.

Clause 40. The method of any one of clauses 20-39, wherein the video generation neural network is a video diffusion neural network.

Clause 41. The method of clause 40, wherein the video generation neural network is a video latent diffusion neural network.

Clause 42. The method of any one of clauses 20-41, wherein, for each initial training example, the initial conditioning input comprises text or audio characterizing one or more properties of the target video.

Clause 43. The method of any one of clauses 20-42, wherein, for each initial training example, the initial conditioning input comprises one or more context images for the target video.

Clause 44. The method of any preceding clause, wherein the video generation neural network is a rectified flow generative neural network.

Clause 45. The method of any one of clauses 1-43, wherein the video generation neural network is a multistep consistency generative neural network.

Clause 46. The method of any preceding clause, further comprising:
obtaining a plurality of conditioning inputs, each conditioning input being for generating an output video that spans a particular time window, wherein the conditioning input comprises (i) the camera motion input that specifies the target motion of the camera that captures the output video during the particular time window, (ii) a subject motion input that specifies a target motion of a subject depicted in the output video during the particular time window, or (iii) both; and
for each of the plurality of conditioning inputs, processing the conditioning input using the video generation neural network to generate a corresponding output video; and
selecting one or more of the conditioning inputs based on the output videos.

Clause 47. The method of clause 46, further comprising generating, based on the selected one or more conditioning inputs, (i) camera motion control data for controlling motion of a camera in a real-world environment, (ii) subject motion control data for controlling motion of a physical object in a real-world environment, or (iii) both.

Clause 48. The method of clause 47, wherein obtaining a plurality of conditioning inputs comprises for each conditioning input, receiving, via a camera motion control interface, the camera motion input specifying a target motion of the camera.

Clause 49. The method of clause 47 or 48, further comprising using the camera motion control data to control the motion of a camera in the real-world environment.

Clause 50. The method of any one of clauses 46 to 49, further comprising using the subject motion control data to control the motion of the physical object in the real-world environment.

Clause 51. The method of clause 50, wherein the physical object is a robot.

Clause 52. The method of any one of clauses 46-51, further comprising generating a plurality of training examples for training an autonomous system, each training example comprising a corresponding one or more of the output videos, wherein each output video depicts a view of an environment from a camera of the autonomous system.

Clause 53. The method of clause 52, wherein (i) the camera motion input specifies a target motion of the camera of the autonomous system, (ii) the subject motion input specifies a target motion of a physical object in an environment of the autonomous system, or (iii) both.

Clause 54. The method of clause 52 or 53, further comprising using the plurality of training examples to train the autonomous system to process observations of a real-world environment to perform a predetermined task in the real-world environment.

Clause 55. The method of any one of clauses 52-54, wherein the autonomous system comprises a self-driving vehicle or robot.

Clause 56. The method of any preceding clause, further comprising, after the training:
generating a camera motion input based on control inputs received from an operator of a remote vehicle;
obtaining a conditioning input for generating an output video that spans a particular time window, wherein the conditioning input comprises the camera motion input that specifies the target motion of the camera that captures the output video during the particular time window; wherein the output video depicts a view from a camera of the remote vehicle or from a camera observing the remote vehicle; and
displaying the output video to the operator of the remote vehicle.

Clause 57. The method of clause 56, wherein the control inputs received from the operator are used to control the remote vehicle.

Clause 58. a System Comprising:
one or more computers; and
one or more storage devices communicatively coupled to the one or more computers, wherein the one or more storage devices store instructions that, when executed by the one or more computers, cause the one or more computers to perform the operations of the respective method of any one of clauses 1-57.

Clause 59. One or more non-transitory computer storage media storing instructions that when executed by one or more computers cause the one or more computers to perform the operations of the respective method of any one of clauses 1-57.

Clause 1.1. A method performed by one or more computers, the method comprising:
obtaining a video captured by a camera and comprising a sequence comprising a plurality of video frames;
generating, for each of at least a subset of the plurality of video frames, respective camera track data specifying a position of the camera when the video frame was captured;
for each of a set of one or more segments of the video:
   generating, from the respective camera track data for the video frames in the segment, an input to a generative neural network; and
   processing the input using the generative neural network to generate a text description of motion of the camera during the video.

Clause 1.2. The method of clause 1.1, further comprising:
for each of a plurality of segments of the video:
   determining whether at least a threshold proportion of the video frames in the segment have respective camera track data; and
   only including the segment in the set of one or more segments when at least a threshold proportion of the video frames in the segment have respective camera track data.

Clause 1.3. The method of any one of clauses 1.1 or 1.2, wherein the respective camera track data comprises a three-dimensional camera position and orientation of the camera when the video frame was captured.

Clause 1.4. The method of any one of clauses 1.1-1.3, wherein generating, from the respective camera track data for the video frames in the segment, an input to a generative neural network comprises:
generating, from the respective camera track data for the video frames in the segment, a sequence of camera positions and rotation velocities of the camera.

Clause 1.5. The method of clause 1.4, wherein the sequence of camera positions and rotation velocities includes, for each of one or more video frames in the segment:
a respective horizontal velocity of the camera as of the video frame;
a respective vertical velocity of the camera as of the video frame; and
a respective forward/backward velocity of the camera as of the video frame.

Clause 1.6. The method of clause 1.5, wherein the sequence of camera positions and rotation velocities includes, for each of one or more video frames in the segment:
a respective pitch of the camera as of the video frame;
a respective yaw of the camera as of the video frame; and
a respective roll of the camera as of the video frame.

Clause 1.7. The method of any one of clauses 1.1-1.6, wherein the input comprises one or more examples, each example comprising (i) an example input generated from example camera motion data for an example video segment and (ii) an example text description describing motion of a camera during the example video segment.

Clause 1.8. The method of any one of clauses 1.1-1.7, wherein generating, for each of at least a subset of the plurality of video frames, respective camera track data specifying a position of the camera when the video frame was captured comprises:
applying a camera posing algorithm to the video to generate the camera track data.

Clause 1.9. The method of clause 1.8, wherein the camera posing algorithm is a Simultaneous Localization and Mapping (SLAM)-based algorithm.

Clause 1.10. The method of any one of clauses 1.1-1.9, further comprising:
generating a training example comprising (i) a training conditioning input that comprises the text description of the one or more segments of the video and (ii) a target output that comprises the one or more segments of the video; and
training a video generation neural network on training data comprising the training example, wherein the video generation neural network is configured to process a conditioning input for generating an output video that spans a particular time window and that comprises a camera motion input that specifies a target motion of a camera during the particular time window.

Clause 1.11. The method of clause 1.10, further comprising, after the training:
obtaining the conditioning input for generating the output video that spans the particular time window, wherein the conditioning input comprises the camera motion input that specifies the target motion of the camera that captures the output video during the particular time window; and
processing the conditioning input using the video generation neural network to generate the output video.

Clause 1.12. The method of clause 1.11, wherein the output video depicts a subject, and wherein the conditioning input comprises a subject motion input that specifies a target motion of the subject during the particular time window.

Clause 1.13. The method of clause 1.12, wherein the subject motion input specifies the target motion of the subject relative to the target motion of the camera during the particular time window.

Clause 1.14. The method of clause 1.13, wherein the subject motion input is one of a set of subject motion labels that each represent a different subject motion.

Clause 1.15. The method of clause 1.14, wherein processing the conditioning input using a video generation neural network to generate the output video comprises tokenizing the subject motion label into a set of one or more tokens and conditioning the video generation neural network on the set of one or more tokens.

Clause 1.16. The method of clause 1.11, wherein the camera motion input is one of a set of camera motion labels that each represent a different camera motion.

Clause 1.17. The method of clause 1.16, wherein processing the conditioning input using a video generation neural network to generate the output video comprises tokenizing the camera motion label into a set of one or more tokens and conditioning the video generation neural network on the set of one or more tokens.

Clause 1.18. The method of clause 1.12, wherein the subject motion input comprises a respective score for each of a set of a plurality of subject motion labels that each represent a different subject motion.

Clause 1.19. The method of clause 1.18, wherein processing the conditioning input using a video generation neural network to generate the output video comprises tokenizing the respective scores for the subject motion labels into a set of one or more tokens and conditioning the video generation neural network on the set of one or more tokens.

Clause 1.20. The method of clause 1.11, wherein the camera motion input comprises a respective score for each of a set of a plurality of camera motion labels that each represent a different camera motion.

Clause 1.21. The method of clause 1.20, wherein processing the conditioning input using a video generation neural network to generate the output video comprises tokenizing the respective scores for the camera motion labels into a set of one or more tokens and conditioning the video generation neural network on the set of one or more tokens.

Clause 1.22. The method of any one of clauses 1.15, 1.17, 1.19, or 1.21, wherein each token in the set of one or more tokens is encoded with a respective temporal positional encoding.

Clause 1.23. The method of any one of clauses 1.10-1.22, wherein the video generation neural network is a video diffusion neural network.

Clause 1.24. The method of any one of clauses 1.10-1.23, wherein the video generation neural network is a video latent diffusion neural network.

Clause 1.25. The method of any one of clauses 1.10-1.24, wherein the conditioning input further comprises text or audio characterizing one or more properties of the output video.

Clause 1.26. The method of any one of clauses 1.10-1.25, wherein the conditioning input further comprises one or more context images for the output video.

Clause 1.27. The method of any one of clauses 1.10-1.26, wherein training the video generation neural network comprises:
obtaining a plurality of initial training examples, each training example comprising (i) an initial conditioning input and (ii) a target video that spans a corresponding time window and is characterized by the initial conditioning input;
for each initial training example:
   processing a first input comprising (i) the target video in the initial training example or (ii) features of the target video in the initial training example using a camera motion classifier neural network to generate a camera motion output that characterizes a motion of a camera that captured the target video during the corresponding time window; and
   generating a final training example that comprises (i) a conditioning input that comprises the initial conditioning input in the initial training example and the camera motion output and (ii) the target video in the initial training example; and
training the video generation neural network on the final training examples.

Clause 1.28. The method of clause 1.27, wherein, prior to training the video generation neural network on the final training examples, the video generation neural network has been trained on a set of training examples that do not include camera motion outputs.

Clause 1.29. The method of clause 1.27 or 1.28, wherein:
each target video depicts a respective subject,
the method further comprises, for each initial training example:
   processing a second input comprising (i) the target video in the initial training example or (ii) the features of the target video in the initial training example using a subject motion classifier neural network to generate a subject motion output that characterizes a motion of the respective subject depicted in the target video during the corresponding time window;
wherein the conditioning input in the final training example for the initial training example further comprises the subject motion output.

Clause 1.30. The method of any one of clauses 1.1-1.29, when dependent on clause 1.27, wherein the camera motion classifier neural network has been trained using the text descriptions of motion of the camera for the one or more segments.

Clause 1.31. The method any one of clauses 1.1-1.30, when dependent on clause 1.10, wherein training the video generation neural network comprises:
obtaining a plurality of initial training examples, each training example comprising (i) an initial conditioning input and (ii) a target video that spans a corresponding time window and is characterized by the initial conditioning input, wherein each target video depicts a respective subject;
for each initial training example:
   processing a second input comprising (i) the target video in the initial training example or (ii) the features of the target video in the initial training example using a subject motion classifier neural network to generate a subject motion output that characterizes a motion of the respective subject depicted in the target video during the corresponding time window; and
   generating a final training example that comprises (i) a conditioning input that comprises the initial conditioning input in the initial training example and the subject motion output and (ii) the target video in the initial training example; and
training the video generation neural network on the final training examples.

Clause 1.32. The method of clause 1.31, wherein the method further comprises, for each initial training example:
processing a first input comprising (i) the target video in the initial training example or (ii) features of the target video in the initial training example using a camera motion classifier neural network to generate a camera motion output that characterizes a motion of a camera that captured the target video during the corresponding time window;
wherein the conditioning input in the final training example for the initial training example further comprises the camera motion output.

Clause 1.33. The method of clause 1.32, wherein the subject motion classifier neural network and the camera motion classifier neural network are different neural networks.

Clause 1.34. The method of clause 1.32, wherein the subject motion classifier neural network and the camera motion classifier neural network are the same neural network and the first input is the same as the second input.

Clause 1.35. The method any one of clauses 1.1-1.3 when dependent on clause 1.10, further comprising, after the training:
obtaining a plurality of conditioning inputs, each conditioning input being for generating an output video that spans a particular time window, wherein the conditioning input comprises (i) the camera motion input that specifies the target motion of the camera that captures the output video during the particular time window, (ii) a subject motion input that specifies a target motion of a subject depicted in the output video during the particular time window, or (iii) both; and
for each of the plurality of conditioning inputs, processing the conditioning input using the video generation neural network to generate a corresponding output video; and
selecting one or more of the conditioning inputs based on the output videos.

Clause 1.36. The method of clause 1.35, further comprising generating, based on the selected one or more conditioning inputs, (i) camera motion control data for controlling motion of a camera in a real-world environment, (ii) subject motion control data for controlling motion of a physical object in a real-world environment, or (iii) both.

Clause 1.37. The method of clause 1.36, wherein obtaining a plurality of conditioning inputs comprises for each conditioning input, receiving, via a camera motion control interface, the camera motion input specifying a target motion of the camera.

Clause 1.38. The method of clause 1.36 or 1.37, further comprising using the camera motion control data to control the motion of a camera in the real-world environment.

Clause 1.39. The method of any one of clauses 1.36 to 1.38, further comprising using the subject motion control data to control the motion of the physical object in the real-world environment.

Clause 1.40. The method of clause 1.39, wherein the physical object is a robot.

Clause 1.41. The method of any one of clauses 1.35-1.40, further comprising generating a plurality of training examples for training an autonomous system, each training example comprising a corresponding one or more of the output videos, wherein each output video depicts a view of an environment from a camera of the autonomous system.

Clause 1.42. The method of clause 1.41, wherein (i) the camera motion input specifies a target motion of the camera of the autonomous system, (ii) the subject motion input specifies a target motion of a physical object in an environment of the autonomous system, or (iii) both.

Clause 1.43. The method of clause 1.41 or 1.42, further comprising using the plurality of training examples to train the autonomous system to process observations of a real-world environment to perform a predetermined task in the real-world environment.

Clause 1.44. The method of any one of clauses 1.41-1.43, wherein the autonomous system comprises a self-driving vehicle or robot.

Clause 1.45. The method any one of clauses 1.1-1.44 when dependent on clause 1.10, further comprising, after the training:
generating a camera motion input based on control inputs received from an operator of a remote vehicle;
obtaining a conditioning input for generating an output video that spans a particular time window, wherein the conditioning input comprises the camera motion input that specifies the target motion of the camera that captures the output video during the particular time window;
processing the conditioning input using the video generation neural network to generate the output video, wherein the output video depicts a view from a camera of the remote vehicle or from a camera observing the remote vehicle; and
   displaying the output video to the operator of the remote vehicle.

Clause 1.46. The method of clause 1.45, wherein the control inputs received from the operator are used to control the remote vehicle.

Clause 1.47. A system comprising:
one or more computers; and
one or more storage devices communicatively coupled to the one or more computers, wherein the one or more storage devices store instructions that, when executed by the one or more computers, cause the one or more computers to perform the operations of the respective method of any one of clauses 1.1-1.46.

Clause 1.48. One or more non-transitory computer storage media storing instructions that when executed by one or more computers cause the one or more computers to perform the operations of the respective method of any one of clauses 1.1-1.46.

What is claimed is:

1. A method performed by one or more computers, the method comprising:
obtaining a conditioning input for generating an output video that spans a particular time window, wherein the conditioning input comprises a camera motion input that specifies a target motion of a camera that captures the output video during the particular time window; and
processing the conditioning input using a video generation neural network to generate the output video.

2. The method of claim 1, wherein the output video depicts a subject, and wherein the conditioning input comprises a subject motion input that specifies a target motion of the subject during the particular time window.

3. The method of claim 2, wherein the subject motion input specifies the target motion of the subject relative to the target motion of the camera during the particular time window.

4. A method performed by one or more computers, the method comprising:
obtaining a conditioning input for generating an output video that depicts a subject and that spans a particular time window, wherein the conditioning input comprises a subject motion input that specifies a target motion of the subject during the particular time window; and
processing the conditioning input using a video generation neural network to generate the output video.

5. The method of claim 4, wherein the conditioning input comprises a camera motion input that specifies a target motion of a camera that captures the output video during the particular time window.

6. The method of claim 5, wherein the subject motion input specifies the target motion of the subject relative to the target motion of the camera during the particular time window.

7. The method of claim 4, wherein the subject motion input is one of a set of subject motion labels that each represent a different subject motion.

8. The method of claim 7, wherein processing the conditioning input using a video generation neural network to generate the output video comprises tokenizing the subject motion label into a set of one or more tokens and conditioning the video generation neural network on the set of one or more tokens.

9. The method of claim 5, wherein the camera motion input is one of a set of camera motion labels that each represent a different camera motion.

10. The method of claim 9, wherein processing the conditioning input using a video generation neural network to generate the output video comprises tokenizing the camera motion label into a set of one or more tokens and conditioning the video generation neural network on the set of one or more tokens.

11. The method of claim 4, wherein the subject motion input comprises a respective score for each of a set of a plurality of subject motion labels that each represent a different subject motion.

12. The method of claim 11, wherein processing the conditioning input using a video generation neural network to generate the output video comprises tokenizing the respective scores for the subject motion labels into a set of one or more tokens and conditioning the video generation neural network on the set of one or more tokens.

13. The method of claim 5, wherein the camera motion input comprises a respective score for each of a set of a plurality of camera motion labels that each represent a different camera motion.

14. The method of claim 13, wherein processing the conditioning input using a video generation neural network to generate the output video comprises tokenizing the respective scores for the camera motion labels into a set of one or more tokens and conditioning the video generation neural network on the set of one or more tokens.

15. The method of claim 4, wherein the conditioning input further comprises text or audio charactering one or more properties of the output video.

16. The method of claim 4, wherein the conditioning input further comprises one or more context images for the output video.

17. The method of claim 5, wherein the video generation neural network has been trained on training examples that are generated by mapping camera track data for an input video segment to a camera motion label for the input video segment using a generative neural network.

18. A method performed by one or more computers and for training a video generation neural network that generates output videos conditioned on respective conditioning inputs, the method comprising:
obtaining a plurality of initial training examples, each training example comprising (i) an initial conditioning input and (ii) a target video that spans a corresponding time window and is characterized by the initial conditioning input;
for each initial training example:
processing a first input comprising (i) the target video in the initial training example or (ii) features of the target video in the initial training example using a camera motion classifier neural network to generate a camera motion output that characterizes a motion of a camera that captured the target video during the corresponding time window; and
generating a final training example that comprises (i) a conditioning input that comprises the initial conditioning input in the initial training example and the camera motion output and (ii) the target video in the initial training example; and
training the video generation neural network on the final training examples.

19. The method of claim 18, wherein:
each target video depicts a respective subject,
the method further comprises, for each initial training example:
processing a second input comprising (i) the target video in the initial training example or (ii) the features of the target video in the initial training example using a subject motion classifier neural network to generate a subject motion output that characterizes a motion of the respective subject depicted in the target video during the corresponding time window;
wherein the conditioning input in the final training example for the initial training example further comprises the subject motion output.

20. The method of claim 18, wherein the first input comprises the features and wherein the features comprise features of an optical flow prediction for the video frames in the target video.
